(19) United States
(12) Patent Application Publication
(10) Pub. No.: US 2007/0133516 A1
(43) Pub. Date: Jun. 14, 2007

(54) Method and apparatus for selecting a codec in a packet-switched communication network

(75) Inventor: Robert C. Stein, Coopersburg, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/300,118

(22) Filed: Dec. 14, 2005

(51) Int. Cl. H04L 12/66; H04L 12/28

(52) U.S. Cl. 370/352; 370/395.2

(57) ABSTRACT

The present invention discloses an apparatus and method for selecting a codec for a connection in a packet-switched communications network are described. In one embodiment, a connection request generated by a user device is detected. A session identifier is then detected in response to the connection request. Afterwards, the session identifier is compared with a session identifier list. In the event the session identifier matches an entry in the session identifier list, a non-compressing codec, or other codec suited to the application, is selected. In response, the connection is established using the non-compressing codec.

### BACKGROUND OF THE INVENTION

1. Field of the Invention

Embodiments of the present invention generally relate to content delivery networks, e.g., packet cable networks. More specifically, the present invention relates to a method and apparatus for selecting a codec for a connection in a packet-switch communication network.

2. Description of the Related Art

Presently, problems frequently arise in certain voice-enabled broadband access network systems (e.g., cable and DSL access networks) that support voice band data devices, such as, data modems, fax machines, telephony devices for the deaf (TDD), and home alarm systems. These problems are typically caused by compressing codecs that are initially designated by a call management server to process calls and telephony based services. Specifically, connections involving voice band data devices typically fail because the analog modulated tones that are transmitted by the devices cannot pass through the default compressing codecs with sufficient fidelity. Consequently, the system responds by taking certain measures to modify the connection parameters (e.g., switching to a non-compressing codec) in order to properly process the session. However, by the time these modifications procedures are completed, the session connection has often already failed.

Thus, there is a need in the art for a method and apparatus for selecting a codec that will ensure that a higher quality of service is established at the onset of a connection.

### SUMMARY OF THE INVENTION

In one embodiment, an apparatus and method for selecting a codec for a connection in a packet-switched communications network are described. Specifically, a connection request generated by a user device is detected. A session identifier is then detected in response to the connection request. Afterwards, the session identifier is compared with a session identifier list. In the event the session identifier matches an entry in the session identifier list, a non-compressing codec, or other codec suited to the application, is selected. In response, the connection is established using the non-compressing codec.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an exemplary block diagram of a telephony network system utilized in accordance with the present invention;

FIG. 2 depicts a general method for selecting a codec for a connection in a packet-switched communications network in accordance with the present invention;

FIG. 3 depicts a first method for selecting a codec for a connection in a packet-switched communications network in accordance with the present invention;

FIG. 4 depicts a second method for selecting a codec for a connection in a packet-switched communications network in accordance with the present invention; and

FIG. 5 is a block diagram depicting an exemplary embodiment of a multimedia terminal adapter (MTA) suitable for implementing the processes and methods described herein.

To facilitate understanding, identical reference numerals have been used, wherever possible, to designate identical elements that are common to the figures.

### DETAILED DESCRIPTION

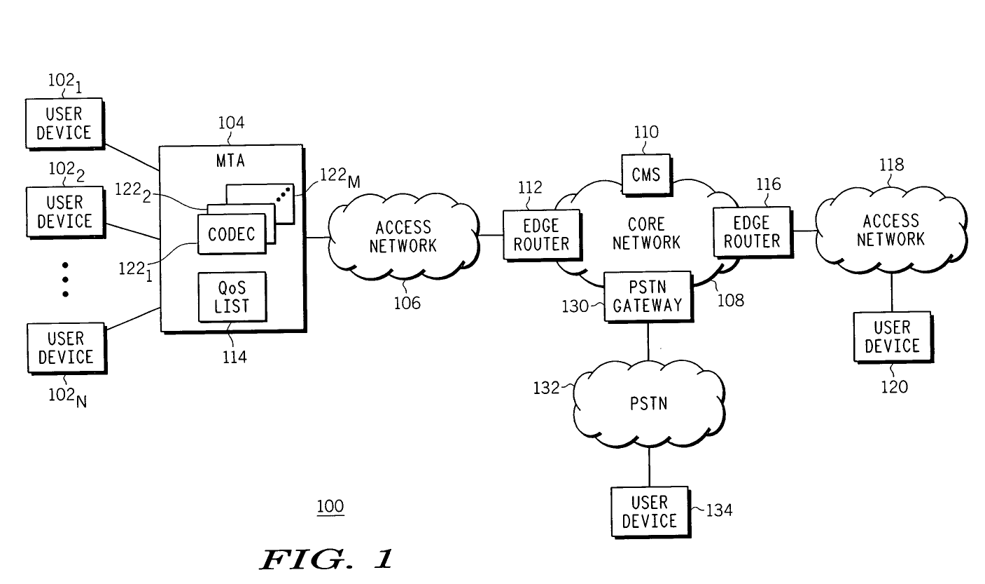

FIG. 1 illustrates an exemplary embodiment of a telephony system architecture 100 in accordance with one or more aspects of the invention. The architecture 100 includes user devices 102_{1 . . . n} (collectively referred to as user devices 102), a multimedia terminal adapter (MTA) 104, an access network 106, a core network 108, an access network 118, and a data communication device 120 supplied by the subscriber, or end user, such as a data modem, facsimile machine, telephony device for the deaf, or home monitoring (alarm) system. The core network 108 comprises a packet-switched communication network, e.g., a voice-over internet protocol (VOIP) network. The core network 108 is illustratively shown as including an edge router 112, a call management server (CMS) 110, a public switched telephone network (PSTN) gateway 130, and an edge router 116. The MTA 104 provides an interface between the user devices 102_{1 . . . n} and the access network 106. The access network 106 is coupled to the edge router 112. The user device 120 is coupled to the access network 118, which is in turn coupled to the edge router 116. Call connections (also referred to as sessions) are established between the user devices 102 and the user device 120 through the MTA 104, the access network 106, the core network 108, and the access network 118. The PSTN gateway 130, which may comprise a server or router, connects the core network 108 to a PSTN 132. The PSTN 132 may comprise any system that carries analog data to at least one user device 134.

The user devices 102_{1 . . . n}, 120, and 134 may comprise voice band data devices (or systems), such as fax machines, data modems, home security/alarm systems, Telephony Devices for the Deaf (TDD), or like devices (generally referred to as time division multiplexing (TDM) devices). The MTA 104 provides the requisite interworking functions between the user devices 102 and the access network 106. Although only one MTA is shown in FIG. 1, those skilled in the art realize a plurality of MTAs could be employed in the system architecture 100. For example, the MTA 104 may comprise a DOCSIS residential gateway or a digital subscriber line (DSL) residential gateway. The access networks 106 and 118 may comprise any type of packet networks known in the art, such as asynchronous transfer mode (ATM) networks, cable television networks, Ethernet networks, Internet Protocol (IP) networks, and the like. The CMS 110 is configured for communication with the edge routers 112 and 116 over the core network 108. The CMS 110, also known as the “Call Agent,” is normally implemented as a media gateway controller or software switch that executes network wide call control related functions.

The MTA 104 contains a plurality of different compressors/decompressors (“codecs”) 122_{1 . . . m} (collectively referred to as codecs 122). The codecs 122_{1 . . . m} may include both compressing codecs and non-compressing codecs. A compressing codec is configured to encode input audio data for transmission using a digital compression technology. Exemplary compressing codecs include a G.729e codec, a G.723 codec, a G.728 codec, an iLBR codec, and the like. A non-compressing codec is configured to encode input audio data without any loss or compression. Exemplary non-compressing codecs include a G.711 codec, a G.726-40 codec, and the like. For a given session, the MTA 104 employs one of the codecs 122 to process the audio data of the session. In accordance with one embodiment of the invention, the MTA 104 is configured to select one of the codecs 122 based on the type of the session, namely, a voice session or a data session (e.g., a fax transmission).

Notably, the compressing codecs may be used to service certain phone calls or sessions that do not require a high Quality of Service (QOS) level. These codecs are commonly used by a network due to their low bandwidth requirements which reduce costs. For example, a compressing codec may be used with a voice session. Alternatively, non-compressing codecs may be used for sessions requiring a higher QOS level. For example, in a data session, the analog modulated tones produced in such a session may be compromised when processed by compressing codecs, i.e., the transmitted tones do not pass through the codecs with sufficient fidelity. Consequently, data sessions may fail if a compressing codec is employed.

The MTA 104 is preferably configured to determine the type of session using a Quality of Service (QOS) session identifier list 114. The QOS session identifier list 114 stores QOS session identifiers for destination user devices, such as telephone directory numbers, session initiation protocol (SIP) universal resource identifiers (URIs), and the like. In one embodiment, the QOS session identifier list 114 may also contain feature activation codes (also known as vertical service codes). The session identifiers stored in the list 114 are associated with destination user devices or telephone directory numbers that require a high QOS, e.g., destination devices in data sessions. The QOS session identifier list 114 may be stored in non-volatile memory, such as an electrically-erasable programmable read only memory (e.g., Flash memory), magneto-resistive Random Access Memory (MRAM), ferroelectric RAM (FRAM), and the like.

In one embodiment, QOS session identifiers may be added to the QOS session identifier list 114 by a network operator or a subscriber using a personal computer to access a web portal. Alternatively, the subscriber may add session identifiers to the QOS session identifier list 114 via a telephone keypad by, for example, entering a feature activation code (e.g., *95) and then a telephone number to add. In yet another embodiment, the subscriber may add session identifiers to the QOS session identifier list 114 using a configuration interface of the MTA 104 (e.g., accessing the MTA 104 using a web browser). Notably, these mechanisms for adding a session identifier to the list 114 may be also used to retrieve or delete QOS session identifiers in a similar fashion.

The quality of service (QOS) session identifier list 114 also stores configuration for the level of quality of service required for the sessions. In one embodiment, the level of quality of service is specified by selection of the appropriate codec to use for sessions established with the end user device requiring quality of service. When configuring entries in the QOS session identifier list through a web browser, which may be one method for such configuration, the subscriber selects from a list of those available from the multiplicity of codecs 122_{1 . . . m} provided in the MTA 104.

The MTA 104 may be configured to perform codec selection based on session type for various types of call signaling employed by the core network 110. In one embodiment, the core network 110 employs media gateway control protocol (MGCP) and/or network-based call signaling (NCS) (generally referred to as NCS). For a given session, the CMS 110 initially instructs the MTA 104 to use a compressing codec by default due to bandwidth and cost concerns. In particular, the MTA 104 is configured to detect if any of the user devices 102 goes “off-hook”. If a given device is off-hook, the MTA 104 sends an “off-hook” notification message to the CMS 110. The CMS 110 instructs the MTA 104 to gather dialed digits from the user device. The dialed digits comprise the session identifier. The MTA 104 collects the dialed digits and sends a notification of the session identifier to the CMS 110. The MTA 104 also compares the session identifier with the entries in the QOS session identifier list 114. If the session identifier is found in the list 114, the MTA 104 will perform subsequent modification of connection parameters, as discussed below. If the session identifier is not in the list 114, the MTA 104 will accept the connection parameters as set by the CMS 110.

In particular, the CMS 110 sends a create connection request message to the MTA 104 in order to setup a connection. For example, the request message may comprise a session description protocol (SDP) message. The request message contains a prioritized list of codecs that can be used to process audio data during the session. The prioritized list typically specifies a compressing codec (e.g., G.729e codec) as the first, i.e., default, codec on the list, followed by a non-compression codec. If the MTA 104 found the session identifier in the QOS session identifier list 114, the MTA 104 modifies the create connection request message to select the non-compressing codec from the prioritized list. The MTA 104 then returns a response message for the create connection request message to the CMS 110, which continues its processing to establish the session. If the MTA 104 did not locate the session identifier in the QOS session identifier list 114, the MTA 104 does not modify the priority of codecs in the request message. Thus, the default codec selected by the CMS 110 is used for the session.

In another embodiment, the core network 110 employs session initiation protocol (SIP) signaling to establish connections between user devices. For a given session, the MTA 104 detects when a user device goes off-hook and gathers the dialed digits comprising the session identifier. The MTA 104 builds an SIP INVITE message for the session. The SIP INVITE message includes a requested codec to be used for the session. The MTA 104 compares the session identifier with the QOS session identifier list 114. If the session identifier is in the list 114, the MTA 104 includes only a non-compressing codec in the INVITE message. If the session identifier is not in the list 114, the MTA 104 may include a compression codec in the INVITE message.

In another embodiment, the QOS session identifier list 114 may contain feature activation codes, e.g. arbitrary dialed strings, which can be utilized by a user to initiate QOS connections on an ad hoc basis. For example, the QOS session identifier list 114 may include feature activation codes that are characterized with a “*” symbol (e.g. *95, *767, etc.). The feature activation code may be used as a prefix to a dialed number in order to invoke QOS handling, i.e., the MTA 104 will recognize the feature activation code as a match in the QOS session identifier list 114 and will consequently process the associated dialed phone number appropriately. This mode of operation, however, requires that the QOS identifier list include additional specifications for treating the identifiers when received by the MTA 104. Namely, the QoS feature activation code may need to be discarded before the dialed number is reported to the CMS 110 or included in a SIP URI. In another embodiment, the MTA 104 may be configured to employ a “learning function.” Notably, the MTA 104 may record (i.e., “remember”) the phone number dialed with a feature activation code after a single use (i.e., ad hoc basis) by the user. Consequently, the MTA 104 may assist the user by remembering a predefined number (e.g., the last 10 ad hoc phone numbers dialed) of dialed telephone numbers. The MTA 104 may then utilize this list by providing the necessary level of service in the event the user dials the phone number again without the feature activation code (e.g., the user forgets to utilize the feature activation code).

The use of the feature activation code, as used with one embodiment of the present invention is described in the following example. Notably, a subscriber may initiate a fax transmission by utilizing a feature activation code (e.g., *95) as a prefix for a destination number. The MTA 104 then detects the off-hook condition and sends a notification message to the CMS 110 or forms a SIP invite message. After detecting the session identifier number, the MTA 104 searches the QOS session identifier list 114 and locates the previously entered feature activation code in the list. The MTA 104 then removes the feature activation code from the session identifier number and sends the remaining dialed digits (i.e., the phone number of the fax recipient) to the CMS 110. Operation then proceeds as described above.

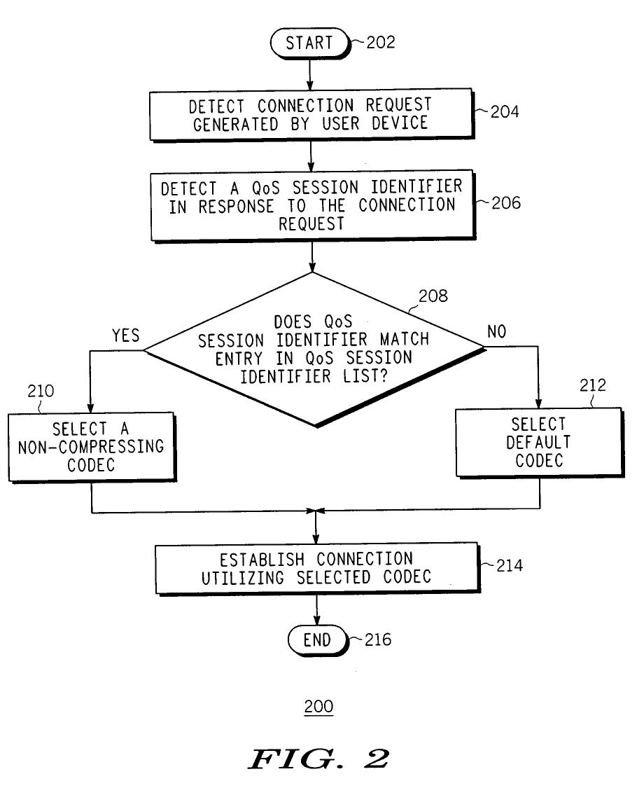

FIG. 2 illustrates a general method 200 for selecting a codec for a connection in a packet-switched communications network in accordance with the present invention. Method 200 begins at step 202 and proceeds to step 204, where a connection request generated by a user device is detected. In one embodiment, the MTA 104 detects a call setup signaling message from a voice band data device (e.g., user device 1021).

At step 206, a QOS session identifier is detected in response to the connection request. In one embodiment, the MTA 104 acquires the voice band data device's phone number. At step 208, the session identifier is compared to a QOS session identifier list 114. In one embodiment, the device's phone number is compared to a plurality of session identifier numbers contained in a QOS session identifier list 114. If the session identifier matches an entry in the QOS session identifier list 114, then the method 200 proceeds to step 210 and a non-compressing codec is selected from the MTA's collection of codecs 122_{1 . . . m}. If the session identifier does not match an entry in the QOS session identifier list, the method 200 continues to step 212 and a default codec is selected from the MTA's collection of codecs 122_{1 . . . m}. After the appropriate codec is selected, the method 200 continues to step 214 where a connection utilizing the selected codec. The method 200 then ends at step 216.

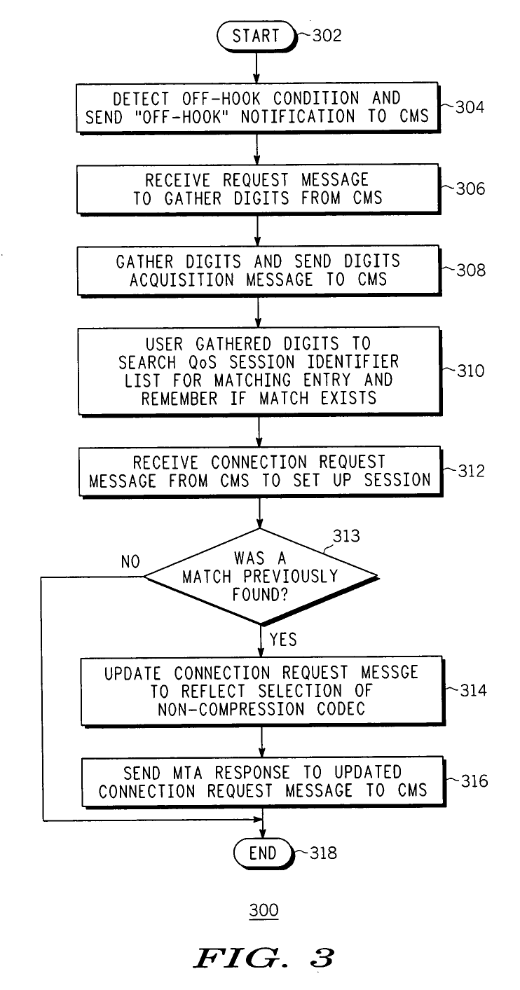

FIG. 3 illustrates an exemplary method 300 for selecting a codec for a connection in a packet-switched communications network in accordance with the present invention. Method 300 begins at step 302 and proceeds to step 304 where an off-hook condition is detected. In one embodiment, the MTA 104 detects a user device 102₁ (e.g., an alarm system) triggering an off-hook condition in an attempt to contact a terminating endpoint (e.g., an alarm monitoring center) and sends an “off-hook” notification to the CMS 110. At step 306, a request message to gather digits is received. In one embodiment, the MTA 104 receives a request message from the CMS 110 to obtain the dialed phone number from the user device 102₁. At step 308, the digits are obtained and a “digits acquisition” message is sent. In one embodiment, the MTA 104 gathers the digits dialed by the user device 102₁ and sends a notification message to the CMS 110.

At step 310, the QOS session identifier list 114 is searched for a matching entry. In one embodiment, the acquired digits are compared to a QOS session identifier list 114 in attempt to find a matching entry. If an entry is found, then the digits are recorded (i.e., “remembered”) for future use. If a matching entry is not found, then the session connection is processed in a conventional manner. At step 312, a connection request message to set up a session is received. In one embodiment, the MTA 104 receives a create connection request (e.g., a CRCX message) from the CMS 110 to setup a connection for the session. Notably, the create connection request contains a preference for the utilization of a compressing codec. At step 313, a determination as to whether the gathered digits (from step 308) matched an entry in the QOS session identifier list 114 is made. If a match was not found, the method 300 proceeds to step 318. If a matching entry was found, then the method 300 continues to step 314.

At step 314, the connection request message is updated to reflect the selection of a non-compressing codec. In one embodiment, the MTA 104 examines the create connection request and subsequently modifies the request by selecting a non-compressing codec from the plurality of codecs 122_{1 . . . m} to replace the default compressing codec. At step 316, the MTA response to the updated connection request message is sent, including the selection of the non-compressing codec. In one embodiment, the MTA 104 returns this information to the CMS 110 in the SDP portion of the message that it updates for the CMS 110. The method 300 then ends at step 318.

FIG. 4 illustrates an exemplary method 400 for selecting a codec for a connection in a packet-switched communications network in accordance with the present invention. Method 400 begins at step 402 and proceeds to step 404 where an off-hook condition is detected. In one embodiment, the MTA 104 detects a user device 102₁ (e.g., an alarm system) triggering an off-hook condition in an attempt to contact a terminating endpoint (e.g., an alarm monitoring center). At step 406, a QOS session identifier is obtained and an INVITE message is generated. In one embodiment, the MTA 104 gathers the dialed digits and builds an INVITE message for the session.

At step 408, a determination is made whether the QOS session identifier (e.g., a destination endpoint identifier) matches an entry in the QOS session identifier list 114. If a match does not exist, then the method 400 proceeds to step 409 where the MTA 104 creates a list of codecs to offer the destination endpoint. If a matching entry does exist, the method 400 continues to step 410. In one embodiment, the dialed digits (e.g., the phone number of the alarm monitoring center) are compared to a QOS session identifier list 114 by the MTA 104. In the event the dialed digits are found to match an entry of the list 114, the MTA 104 will specify a QOS condition. At step 410, a non-compressing codec is listed in the INVITE message. In one embodiment, the MTA 104 includes only the G.711 codec in the SDP offer of the INVITE message, which is ultimately forwarded to the terminating endpoint. The method 400 then ends at step 412.

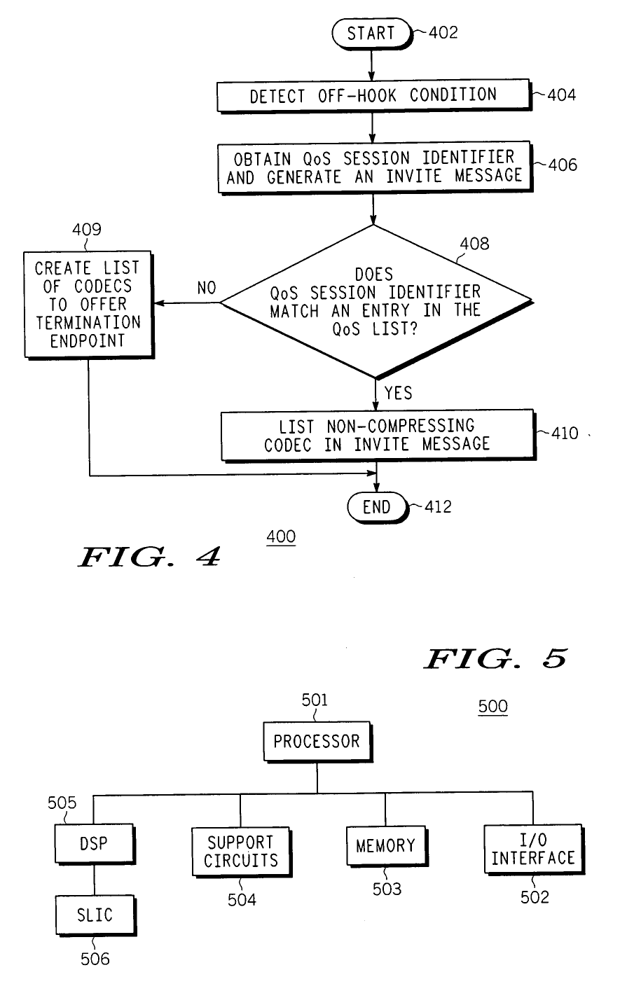

FIG. 5 is a block diagram depicting an exemplary embodiment of the MTA 104 in accordance with one or more aspects of the invention. The MTA 104 preferably includes a processor 501, a memory 503, various support circuits 504, an I/O interface 502, a digital signal processor (DSP) 505, and a subscriber line interface circuit 506. The processor 501 may comprise a microcontroller, a microprocessor, or a like device known in the art. The support circuits 504 for the processor 501 may include conventional cache, power supplies, clock circuits, data registers, and the like. The I/O interface 502, which may comprise a conventional analog telephony interface, is directly coupled to the memory 503 or coupled through the processor 501. In one embodiment, the I/O interface 502 is configured to communicate with user devices (e.g., user devices 102_{1 . . . n} in FIG. 1) and access networks (e.g. access network 106 in FIG. 1). The SLIC 506 may comprise any analog telephony interface that can be used to connect to a user device.

The memory 503 may store all or portions of one or more programs and/or data to implement the processes and methods described herein. Notably, the memory 503 may store the one or more programs to be executed by the processor 501 for performing the methods 200, 300, and 400 of FIGS. 2, 3, and 4. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs. The memory 403 may include one or more non-volatile memory types such as, read only memory, magneto-resistive read/write memory, optical read/write memory, cache memory, magnetic read/write memory, and the like, as well as signal-bearing media as described below.

An aspect of the invention is implemented as a program product for use with a MTA. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media; or (iii) information conveyed to a computer by a communications medium, such as through a computer or telephone network, including wireless communications. The latter embodiment specifically includes information downloaded from the Internet and/or other networks. Such signal-bearing media (e.g., a computer-readable carrier), when carrying computer-readable instructions that direct functions of the invention, represent embodiments of the invention.

While the foregoing is directed to embodiments of the present invention, other and further embodiments of the invention may be devised without departing from the basic scope thereof, and the scope thereof is determined by the claims that follow.

1. A method for selecting a codec for a connection in a packet-switched communications network, comprising:
detecting a connection request generated by a user device;
detecting a session identifier in response to said connection request;
comparing said session identifier with a session identifier list;
selecting a non-compressing codec if said session identifier matches an entry in said session identifier list; and
establishing said connection using said non-compressing codec.

2. The method of claim 1, further comprising:
transmitting a session description protocol (SDP) message that provides an instruction for the use of said non-compressing codec.

3. The method of claim 2, wherein said SDP message is sent to a call management server (CMS).

4. The method of claim 2, wherein said SDP message is included in an INVITE message.

5. The method of claim 1, wherein said session identifier comprises at least one of: a telephone directory number, a feature activation code, or a session initiation protocol (SIP) universal resource identifier (URI).

6. The method of claim 1, wherein said user device comprises at least one of: a fax machine, an alarm system, a Telephony Device for the Deaf (TDD), or a data modem.

7. The method of claim 1, wherein said session identifier list is stored in non-volatile memory.

8. The method of claim 1, further comprising:
receiving a create connection request message listing a plurality of codecs from a call management server (CMS);
selecting said non-compressing codec from said plurality of codecs;
updating said create connection request message to reflect the selection of said non-compressing codec; and
sending said updated create connection request message to said CMS.

9. The method of claim 1, wherein said session identifier list comprises at least one of: a telephone directory number, a feature activation code, or a session initiation protocol (SIP) universal resource identifier (URI).

10. The method of claim 1, wherein said non-compressing codec comprises a user-specified codec appropriate for said connection and said user device.

11. The method of claim 1, wherein at least one session identifier is entered into said session identifier list by a user via a telephone keypad using a feature activation code or via a web portal.

12. A computer-readable carrier having stored thereon a plurality of instructions, the plurality of instructions including instructions which, when executed by a processor, causes the processor to perform the steps of a method for selecting a codec for a connection in a packet-switched communications network, comprising:
detecting a connection request generated by a user device;
detecting a session identifier in response to said connection request;
comparing said session identifier with a session identifier list;
selecting a non-compressing codec if said session identifier matches an entry in said session identifier list; and
establishing said connection using said non-compressing codec.

13. The computer-readable carrier of claim 12, further comprising:
transmitting a session description protocol (SDP) message that provides an instruction for the use of said non-compressing codec.

14. The computer-readable carrier of claim 13, wherein said SDP message is sent to a call management server (CMS).

15. The computer-readable carrier of claim 13, wherein said SDP message is included in an INVITE message.

16. The computer-readable carrier of claim 12, wherein said session identifier comprises at least one of: a telephone directory number, a feature activation code, or a session initiation protocol (SIP) universal resource identifier (URI).

17. The computer-readable carrier of claim 12, wherein said user device comprises at least one of: a fax machine, an alarm system, a Telephony Device for the Deaf (TDD), or a data modem.

18. The computer-readable carrier of claim 12, wherein said session identifier list is stored in non-volatile memory.

19. The computer-readable carrier of claim 12, further comprising:
receiving a create connection request message listing a plurality of codecs from a call management server (CMS);
selecting said non-compressing codec from said plurality of codecs;
updating said create connection request message to reflect the selection of said non-compressing codec; and
sending said updated create connection request message to said CMS.

20. The computer-readable carrier of claim 12, wherein said session identifier list comprises at least one of: a telephone directory number, a feature activation code, or a session initiation protocol (SIP) universal resource identifier (URI).

21. The computer-readable carrier of claim 12, wherein said non-compressing codec comprises a user-specified codec appropriate for said connection and said user device.

22. The computer-readable carrier of claim 12, wherein at least one session identifier is entered into said session identifier list by a user via a telephone keypad using a feature activation code or via a web portal.

23. An apparatus for selecting a codec for a connection in a packet-switched communications network, comprising:
an interface configured to receive a connection request generated by a user device;
a memory configured to store a session identifier list; and
a processor configured to detect a session identifier in response to said connection signal, comparing said session identifier with the session identifier list, selecting a non-compressing codec if said session identifier matches an entry in said session identifier list, and establishing said connection using said non-compressing codec.

24. The apparatus of claim 23, wherein said processor is further configured to receive a create connection request message listing a plurality of codecs from a call management server (CMS), select said non-compressing codec from said plurality of codecs, update said create connection request message to reflect the selection of said non-compressing codec, and send said updated create connection request message to said CMS.
